(19) United States
(12) Patent Application Publication
(10) Pub. No.: US 2007/0187431 A1
(43) Pub. Date: Aug. 16, 2007

(54) Child-proof closure device

(75) Inventor: Edgar Manker, Beaconsfield (CA)

Correspondence Address: Mila Shvartsman, P.O. Box 48652, Outremont, QC, H2V 4T9, CA

(73) Assignee: PHOENIX INTERNATIONAL

(21) Appl. No.: 11/650,611

(22) Filed: Jan. 8, 2007

Related U.S. Application Data
(60) Provisional application No. 60/760,361, filed on Jan. 20, 2006.

(51) Int. Cl. B67B 5/00; B65D 83/00

(52) U.S. Cl. 222/153.11; 222/402.11

(57) ABSTRACT

The present invention relates to a child-proof closure for a container containing a dangerous substance comprising a body adapted to be fitted over a container with a top portion and a continuous side wall depending downwardly from the top portion. The closure comprises a series of interlocking elements on the top portion and the side wall that move in a predetermined sequence to facilitate access to the substance. The interlocking elements are slides adapted to slide within corresponding grooves. The closure further comprises a membrane underneath the top portion comprising an opening provided for limited distribution of the substance. The opening is accessible only after the interlocking elements are in the open position. The closure comprises two vertical slides that interlock opposite sides of a horizontal slide. The horizontal slide moves left and right and the vertical slides move down. The horizontal slide controls access to the container's contents

### BACKGROUND

This invention relates to child resistant closures that have been widely used in the last twenty-five years. The purpose of these closures is to make it more difficult for young children to gain access and subsequently consume dangerous materials including medications in pill or liquid form, and various chemicals including caustics, acids, petroleum products, alcohols, pesticides and the like. Available child resistant closures typically require significant force and coordination to open, and it is difficult for elderly or disabled people to open these closures. Often, once opened, the child resistant closures are not replaced or left in an insecure position due to the difficulty of reopening. There are currently only a few common types of child resistant closures. The most common, and relatively old (U.S. Pat. No. 3,627,160) type is a cap that includes an arrow or pointer that must be rotated and aligned with a corresponding indicator on the bottle. When the arrows are aligned, the cap is pushed up and off the bottle. This closure is easy to use but also provides a relatively low level of child resistance, since most users commonly close the cap with the arrows aligned so that only a pushing or lifting force is needed to remove the cap. This type of cap is often found on bottles containing aspirin or analgesics and on prescription drug bottles where a high level of child resistance is not indicated.

A second type of cap requires downward pressure and then a rotational movement to remove the cap. One version of this “push and unscrew” cap uses lugs on the bottle and corresponding projections on the inner side of the cap, so that when the projections are pushed below the lugs, the cap can be twisted and removed. Another “push down and turn” (U.S. Pat. No. 3,857,505) version uses an internal threaded cap and a second, external cap that is free to rotate when the cap is in the closed, child resistant position. A “push and turn” engages the outer cap with the inner cap, so that maintaining downward pressure while rotating the engaged caps allows the inner cap to be unscrewed. This is perhaps the most difficult to use, and unless the cap is returned to its full locked position, it behaves as any other simple threaded cap.

A variation of the above cap is the “lift and turn” closure, where again, the outer cap is freely rotatable in the closed position. By lifting and turning, the outer cap engages the inner threaded cap, and with continued lifting force, the engaged caps can be unscrewed.

Another common child resistant closure is a “squeeze and turn” design, where squeezing pressure on one or two points depresses locking devices, allowing the cap to be rotated while the squeeze pressure is maintained until the cap is rotated above the locking devices. These squeeze and turn closures are typically used, and only convenient, on large closures of 40 mm or greater in diameter. Smaller closures of this design would require very considerable force and be difficult to operate. A variation of this “squeeze and turn” design is commonly used on containers for antifreeze, windshield washer fluid and the like, comprising a projection external to the cap and a blocking lug or post on the container. This design is based upon U.S. Pat. No. 3,971,487. To open the cap, the projection must be held inwardly depressed while the cap is rotated past the locking lug, allowing removal of the cap.

Another type of child resistant closure can be described as “squeeze and distort”. In this design, squeezing pressure distorts the lower portion of the cap to an elliptical shape so that lugs on the cap that are on an axis 90° from the squeeze points are moved outward from the locking tabs on the container, allowing the cap to be rotated and removed. In one design with multiple locking tabs on the container, it is often necessary to “squeeze and turn” twice to move the cap lugs free of all the locking lugs on the container. This design is found on closures of more than 40 mm diameter where a reasonable squeeze force causes enough distortion to the elliptical shape necessary for the cap lugs to clear the locking lugs of the container. Closures much smaller than 40 mm in diameter would require much higher squeezing forces and close dimensional tolerances between the cap and the container to have an operable design.

A more recent (U.S. Pat. No. 4,948,002) type of “squeeze and turn” design utilizes depressible locking tab prongs that are part of the container. Squeezing the locking prongs inward frees the locking lugs on the cap so that the cap can be rotated and removed. This relatively complex design requires a basic container including a threaded top, a covering shell that includes the locking tab prongs and provides sufficient space between the internal container and the covering shell to allow the locking prongs to be depressed, and a cap comprising a moulded internal threaded form with stiffening ribs and an outer cap including the locking tabs that lock the cap in the closed position. This container and closure is relatively expensive to produce, only provides a small opening for filling, and does not provide an ease of use or level of child resistance that is significantly better than earlier designs.

All of the above child resistant closures depend upon rotational movements to remove the cap, as one would normally expect to unscrew a conventional cap from a container, or similarly to remove a nut from a bolt.

Since about 1970, the Consumer Product Safety Commission (CPSC) of the U.S. Government has actively and successfully promoted the use of child resistant closures to significantly reduce the number of accidental childhood injuries and deaths due to the ingestion of harmful substances. On Jun. 15, 1995, the CPSC voted to issue new rules requiring the child resistant closures to be “adult-friendly and easy to open” while maintaining their child resistance, and to change their test protocol to include more elderly people for evaluating these mandated characteristics of the child resistant closures. The final rules for the test procedures (16 CFR Part 1700) were published in the Federal Register on Jul. 21, 1995.

### SUMMARY OF THE INVENTION

It has been found that novel and entirely different child resistant closures can be made which depend primarily upon the knowledge of their operation and require only a low level of force or strength to operate the closure. The closure consists of a series of interlocking or interrelated slides that, when moved in the proper sequence allow easy opening of the closure and access to the contents of the container. When removing the entire cap from the bottle or container is desirable, the slides can be arranged in a way that once in the “unlocked” position, only a partial rotation, typically less than 90°, is necessary to remove the cap. In cases where the closure also needs to provide a seal against leakage of liquid contents, the closure can also include partial or “interrupted” threads to create the downward force necessary for sealing. Once the slide elements have been moved in proper order and position, a further partial rotation disengages the threads and the cap is easily removed. In this case, the rotation of the child resistant elements plus the rotation to disengage the threads would typically not exceed 120°. Once armed with the knowledge of the function and operation of the closure, its removal is easily accomplished, perhaps more easily than that of a fully threaded cap of conventional design. Another embodiment of the invention provides a child resistant cap that can be used with a conventionally threaded bottle, with only minor modifications to the threaded portion of the bottle.

It is of particular note that the child resistant closures of this invention can be applied to the common commercial aerosol containers and other types of containers that have been generally exempt from, or subject to reduced child resistant standards due to the lack of suitable technology. The child resistant closure devices of this invention can also be applied to a wide variety of containers including bottles, squeeze tubes, eyedroppers, bottles with hand pump dispensers, boxes containing encapsulated medications, the pill boxes containing medications for use when away from home or travelling and other types of containers. The closures utilize similar principles so that an adult familiar with two or three of the closures would probably be able to open other variations without great difficulty, even without specific instructions for that particular closure. Closures for containers as small as 25 mm can easily be produced. In a closure for containers used for antifreeze, windshield washer fluid or the like, the cap could be connected to the container with a retaining cord or strap to prevent accidental misplacement or loss of the cap and the consequential loss of the child resistant protection of the cap.

Additionally, the complexity of the child resistant closure can be varied to adapt to a variety of situations, and to provide child resistant closures effective for a long period of time. Since the operation of the closure depends upon the knowledge of its operation, simple variations allow it to be used by persons who are disabled, blind or illiterate. At the same time, even knowledgeable and educated adults, such as those with mental disorders or suicidal predilection, would have great difficulty in opening more complex versions of the closures unless they were specifically instructed in their use.

Thus, with wide application and proper use by adults, this invention in its various embodiments could reduce the number of childhood injuries and deaths due to accidental ingestion of harmful and poisonous substances to a very low frequency.

A further advantage of the invention is that the shape of the child resistant closure can be varied to allow forms that are suitable for use on products where the shape or “style” of the container is a significant factor in the sale and use of its contents.

### DISCLOSURE OF THE INVENTION

In a basic embodiment, the present invention comprises a package for containing and dispensing potentially dangerous medications, analgesics, iron containing tablets or the like. The package comprises a bottle including two projecting annular rings, with the upper ring being of smaller diameter than the lower ring, and a closure. The closure has a flexible and compressible retaining ring or tabs in its lower internal structure, so that the cap snaps onto the bottle with modest pressure, and is then locked on the bottle, but is also free to rotate. The closure can be installed on a production line, such as for analgesics, or can be installed by a pharmacist or medical technician after a prescribed medication has been dispensed into the bottle.

The closure cap includes three interlocking slides, two vertical and one horizontal. The second, lower ring of the bottle provides a seat or positioning of the cap and also limits the downward movement of the vertical slides. To open the closure, one vertical slide is pushed downward until it reaches the limiting ring of the bottle. In this position, the horizontal slide is moved over the vertical slide until there is a noticeable space between the other end of the horizontal slide and the third vertical slide. This movement disengages a locking tab in the horizontal slide from a slot in the third slide so that it can then be moved downward to the limiting ring of the bottle. The horizontal slide is then moved back over the third slide until an opening in the internal structure of the closure is exposed. The tablets or capsules are then easily dispensed through the opening. After the desired tablet(s) are obtained, the horizontal slide is moved back over the first vertical slide, and the third vertical slide is moved upward to its original position. The top horizontal slide is moved back against the third slide so that the locking tab on the horizontal slide engages the corresponding slot in the vertical slide, thereby locking it in position. The first vertical slide is then moved upward to its original closed position.

Only minimal force is required to move the slides, since knowledge of the mechanism is the key to opening and closing it. Since no alignment of the closure and the bottle is required its use could easily be mastered by the blind or by those whose literacy was little more than the comprehension of arrows and the numbers 1, 2, 3 and 4.

Many other embodiments are disclosed by the subsequent exemplary drawings and a detailed description of the embodiments displayed by the various drawings. The basic embodiment is extremely resistant to opening by a young child, and other embodiments would be virtually impregnable to young hands and minds.

### BRIEF DESCRIPTION OF THE DRAWINGS

The present invention will be better understood from the following description in conjunction with the accompanying drawings in which:

FIG. 1 is a top view of a basic closure device of the present invention.

FIG. 2 is a side view of the same closure together with a bottle designed to retain the closure and operate in conjunction with it.

FIG. 3 is a cross-sectional view of the cap or closure taken through the plane I-I of FIG. 1, showing key elements of the closure.

FIG. 3A shows a perspective view of one vertical slide of FIG. 3;

FIG. 3B is a fragmental perspective view of horizontal slide of FIG. 3.

FIG. 3C is a perspective view of another vertical slide of FIG. 3.

FIG. 3D is another fragmental perspective view of horizontal slide of FIG. 3.

FIG. 3E is a bottom view of closure shown on FIG. 3.

FIG. 4 is a cross-sectional view of the cap taken through the plane II-II of FIG. 2 showing one form of slide shape and the internal structure of the cap or closure.

FIG. 4A is a fragmental cross-sectional view of the tongue-and-groove of Fig.3.

FIG. 5 is a cross-sectional view showing a variant form of slide shape.

FIG. 5A is a perspective view of one vertical slide of FIG.5.

FIGS. 5B and 5D are a fragmental perspective view of horizontal slide of FIG. 5.

FIG. 5C is a perspective view of another vertical slide of FIG. 5.

FIG. 6 is a side view of a closure showing a cap with a curved or rounded shape.

FIG. 6A is a side view of a horizontal slide of FIG. 6.

FIG. 6B is a cross-sectional view of slide arrangement of FIG. 6.

FIG. 7 is a top view of the closure device adapted to restrict the operation of a typical aerosol can assembly.

FIG. 8 is a side view of the closure installed on a typical aerosol valve and actuator.

FIG. 9 is a cross-sectional view of the closure and aerosol can assembly taken through plane V-V of FIGS. 1 and 2.

FIG. 10 is a perspective view of the closure shown in FIGS. 7 and 8 in the open or operable position and condition.

FIG. 11 is a bottom view of the closure device showing an arrangement of the attachment tabs of the closure.

FIG. 12 is a side view of a style of closure device with a curved or rounded form.

FIG. 13 is a top view of a closure device to restrict the operation of an aerosol can assembly with a large cap and a Toggle Actions valve.

FIG. 14 is a side view of the same closure and aerosol valve and can assembly.

FIG. 15 is a cross-sectional view of the closure and aerosol assembly taken through plane X-X of FIG. 13.

FIG. 16 is a cross-sectional view of the detail of the closure, actuator and valve assembly taken through plane XI-XI of FIG. 13.

FIG. 17 is a perspective view of the closure shown in FIGS. 13 and 14 in the open or operable position.

FIG. 18 is a side view of a closure of the type shown in FIGS. 13 and 14 adapted to accept a conventional cover cap.

FIG. 19 is a top view of a closure device designed to allow removal of the cap from the accompanying bottle which is designed to function in concert with the closure.

FIG. 20 is a side view of the same closure and bottle in the normal closed position.

FIG. 21 is a side view of the top of the bottle or container showing details of the design and a phantom outline of the side slide in the closed position.

FIG. 22 is a top view of the bottle design showing details of its structure.

FIG. 23 is a cross-sectional view of the cap assembly taken through plane XV-XV of FIG. 19.

FIG. 24 is a cross-sectional view of the detail of one of the top slides of the cap taken through the plane XVI-XVI of FIG. 19.

FIG. 25 is a cross-sectional view of the detail of the other top slide of the cap taken through the plane XVII-XVII of FIG. 19.

FIG. 26 is a top view another modification of the design shown on FIG. 19.

FIG. 27 is top view of FIG. 26 showing the locking piece moved.

FIG. 28 is a side view of FIG. 26.

FIGS. 29-34 are cross-sectional views showing means of preventing the removal of slides.

### DETAILED DESCRIPTION OF THE INVENTION

FIG. 1 shows a top view of a basic embodiment of the invention. Here, the closure or cap 4 contains three moveable slides 1, 2 and 3 that are interrelated and interlocked with each other. When the closure and container are resting on a horizontal surface such as a counter, table, shelf of a cabinet or the like, slides 1 and 3 are essentially vertical, and slide 2 is horizontal. Only a minor force is necessary to move any one of the slides, since their operation depends upon the knowledge of their use and function. Each slide moves in a plane, and opening and closing of the closure does not require any pressing down, lifting up, squeezing, twisting or a combination of such movements and pressures. In the common resting position, slides 1 and 3 are moved up or down and slide 2 is moved to the right or to the left. No alignment of the closure and the container is required and it can be operated in any position, resting on a surface, held at a 45 degree angle, or inverted. It can be opened and closed in typical home and work situations, underwater, on an aircraft during extreme air turbulence, in outer space or any other location where a virtually child-proof closure might be necessary or desirable.

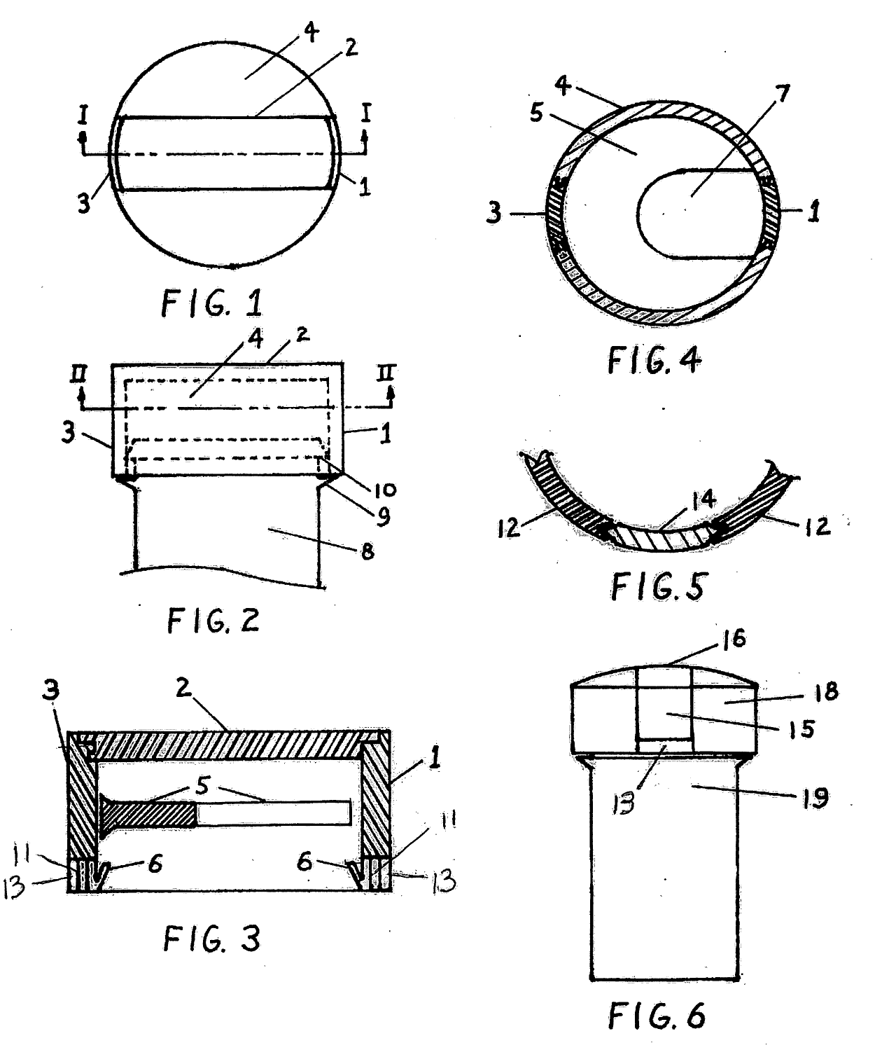

FIG. 2 shows the closure installed on a bottle or container 8 which includes two circular rings 9 and 10. The lower ring 9 serves as a base or seat for the closure and also acts to limit the downward movement of slides 1 and 3. The upper ring 10 retains the closure on the bottle. It should be pointed out that there are no known designs of containers having two complete annular rings as in the present invention, thus is may be understood that the shape and design of the container 8 is an integral part of the embodiment shown on FIGS. 1-4. The annular ring 9 provides a “seat” for the closure 4, but it is clear that it also acts to limit downward movements of slides 1 and 3. A slide guide 11 is provided to facilitate downward movements of slides 1 and 3.

When installed on the bottle, the closure is free to rotate on the bottle, giving the impression to children or those unfamiliar with the closure that rotation is the means of opening the closure. Those familiar with child resistant closures will recognize the bottle as being rather similar to, but distinctly different in design and function from an elementary child resistant closure bottle that has been in wide use for some twenty five years.

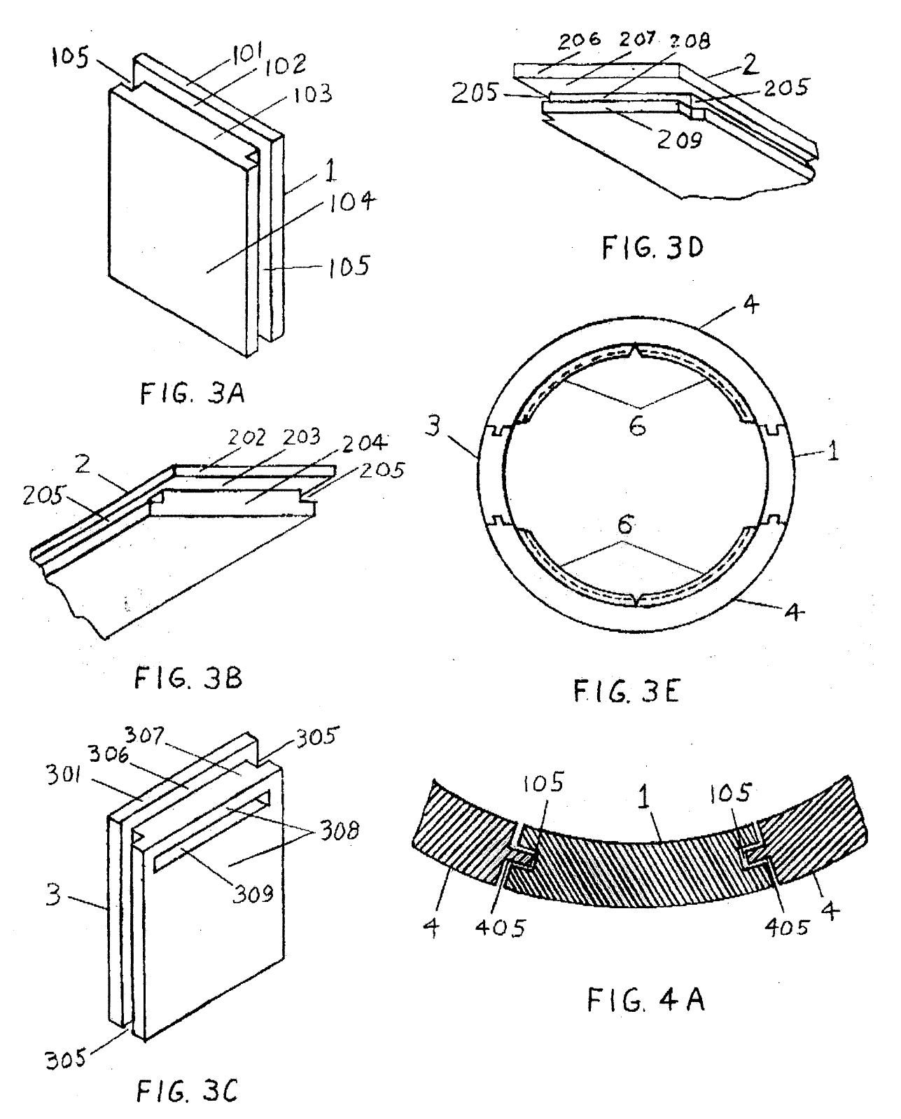

The operation and function of the closure can be seen and clearly understood in FIG. 3, which is a cross-sectional view of the closure in the plane I-I of FIG. 1. Here, it can be seen that slides 1, 2 and 3 are interlocking, and in the closed position only slide 1 can be moved; it can only be moved downward into the free space indicated by 13. To open the closure, slide 1 is moved downward until it is stopped by annular ring 9 of the bottle. When slide 1 is moved down, slide 2 can then be moved to the right and away from slide 3, releasing the interlocking structure of slides 2 and 3. With a small movement of slide 2 to the right, slide 3 can be moved downward into its free space 13 until stopped by ring 9, and slide 2 is then free to be moved to the left.

FIG. 3 also shows the internal structure of the cap, necessary to maintain mechanical rigidity of the cap and the locking tabs 6 which snap under the circular ring 10 of FIG. 2 to secure the closure in position.

FIGS. 3A, B, C and D show details of the slides of FIG. 3. FIG. 3E shows a view of the locking tabs 6 and FIG. 4A shows a detail of the “tongue-and-groove” arrangement of FIG. 4. Slides 1 and 3 have been shown as flat rather than curved for convenience and ease of understanding the interrelationship between the slides. Slide 1 of FIG. 3A includes the surfaces 101, 102, 103 and 104 as well as grooves 105. In the closed position, surface 101 forms part of the top surface of the closure 4. The corresponding end of slide 2 is shown in FIG. 3B. The top of slide 2 forms a part of the top of closure 4. When the closure 4, including slides 1, 2 and 3, is in the closed position, surface 102 of slide 1 mates with surface 202 of slide 2. Similarly, surface 103 mates with surface 203, and the top portion of surface 104 mates with the surface 204. Slide 2 also includes the grooves 205 for movement within the closure body 4.

Referring to FIG. 3 it is clear that in the closed position slide 2 cannot move to the right or to the left. Slide 1 is the only slide that can be moved, and it can only move downward into the open space 13.

FIG. 3C shows the structure of slide 3 and FIG. 3D shows the opposite (left in FIG. 3) end of slide 2. In the closed position, surface 301 forms part of the top surface of closure 4, while surface 206 of slide 2 mates with surface 306 of slide 3. Similarly, surface 207 mates with surface 307, and surface 208 mates with the top of surface 308. The tab 209 is in the slot 309, thus preventing downward movement of slide 3, and the upper end of slide 3 prevents any leftward movement of slide 2.

FIG. 3E is a bottom view of the closure 4 showing the arrangement of the retaining tabs 6. A variety of forms and shapes of retaining tabs are well known in the closure art, and the closure 4 is not restricted to the form of retaining tabs shown on FIGS. 3 and 3E. Any form of retaining tab which restrains the closure 4, such as retaining ring 10, is within the scope of the present invention.

FIG. 4A shows “the tongue-and-groove” detail of slide 1 and the closure 4. The slide 1 includes grooves 105 which relate to and move in concert with the tongues 405 of the closure body 4. The tongue-and-groove design is most commonly seen in wood used for flooring and panelling homes and some commercial structures. In that usage, each piece of wood typically has a tongue formed on one side and a groove formed in the opposite side. In assembly, one piece of wood is placed in position, usually with the tongue at the left of the installer. The next piece has its tongue inserted into the groove of the first piece, and may be tapped into a close fit with a hammer or mallet. The function of the tongue-and-groove design is to provide a finished surface, such as floor, wall or ceiling, which has a smoothness that would be very difficult to attain if boards with simple rectangular cross-sections were used. In the closure 4, the tongue-and-groove forms function similarly to the wood panel example—to provide a smooth closure finish, so that the means of opening the closure 4 is particularly difficult for a child to discern.

An equally important function of the tongue-and-groove design in closure 4 is to provide smooth guide for the slides to move in, thereby minimizing the force or strength necessary to operate the closure. It can be possible, if desired, that slide 1 be formed with tongues that would move in grooves formed as a part of the closure body 4. Any other possible forms of slides or forms of closures functioning in the same way for the same purpose are within the scope of the present invention.

While it may be not obvious, slides 1, 2 and 3 could be removed from closure cap 4 by persons stupid enough to do that. A means of preventing the undesirable removals of those slides is shown on FIGS. 31-34 wherein a reversal (inverting) of the tabs and catches shown on FIGS. 31-34 would limit the upward movement of slides, such as slides 1 and 3.

FIG. 4 is a cross-sectional view taken through plane II-II of FIG. 2. This shows slides 1 and 3 on a “tongue and groove” configuration, and the configuration of slide 2 in cap 4 is identical. The internal structure 5 of the cap includes an opening 7, also depicted in FIG. 3. When slide 2 is moved to the left, any desired portion of the opening 7 can be exposed, allowing egress of pills or capsules from the bottle into the hands of the user.

At this point, some very important aspects of the basic embodiment of the invention should be noted. Operation or opening of the closure does not require any significant physical force, but intimately depends upon the knowledge of its function and operation. If most adults were given the closure without any information or instruction, they would have considerable or greater difficulty in opening the closure and extracting a pill or two from the bottle in any reasonable time. This means that it is only a statistical probability that a young child could open the closure before his or her attention turned to some other object. Since the opening in the closure is limited and can be varied, accidental tipping or dropping of the bottle and closure would only release a few pills rather than most or the entire contents of the bottle. This also means that in the rare circumstance when a child gained access to the contents of the bottle, he could only obtain one or two pills at a time and would probably notice or be repelled by the bad taste of the pills or become bored by the slow process of extracting and swallowing them before he had ingested enough to cause serious physical damage or death.

Since no alignment of the closure and the bottle is required, it is particularly suited to production line operations such as the packaging of analgesics and the like. Also, since the internal diameter of the bottle is only slightly smaller than that of the cap, the bottle could be filled rapidly with pills and with a minimum of “bridging” of pills that is commonly encountered when filling bottles with openings that are only around twice the diameter of the pills in the bottle. At the same time, a pharmacist could fill the bottle with a prescribed medication and install the cap with a reasonable downward pressure. Those still practicing pharmacy or medicine beyond the age of 90 might find it convenient to use a levered press or other force multiplying device to install the closures on the bottles.

A variety of materials may be used in the fabrication of the closures and containers described in the above figures and those shown in later figures demonstrating other embodiments of the invention. Most commonly, plastics such as polypropylene, polystyrene or polycarbonate would be used, but any other material with suitable mechanical properties could be used. In the case of prescription medication containers it is probably preferable to use a transparent plastic such as polystyrene so that the pills or capsules are visible to reduce the chance of a user taking the wrong medication. It is also convenient that the closures and containers are relatively smooth and without any projecting pieces so that mass-produced products such as analgesics and vitamin formulations could easily be covered with a tamper evident film plastic seal. In some embodiments of the invention it might be desirable to use wood, metal or other materials for convenience, appearance and durability.

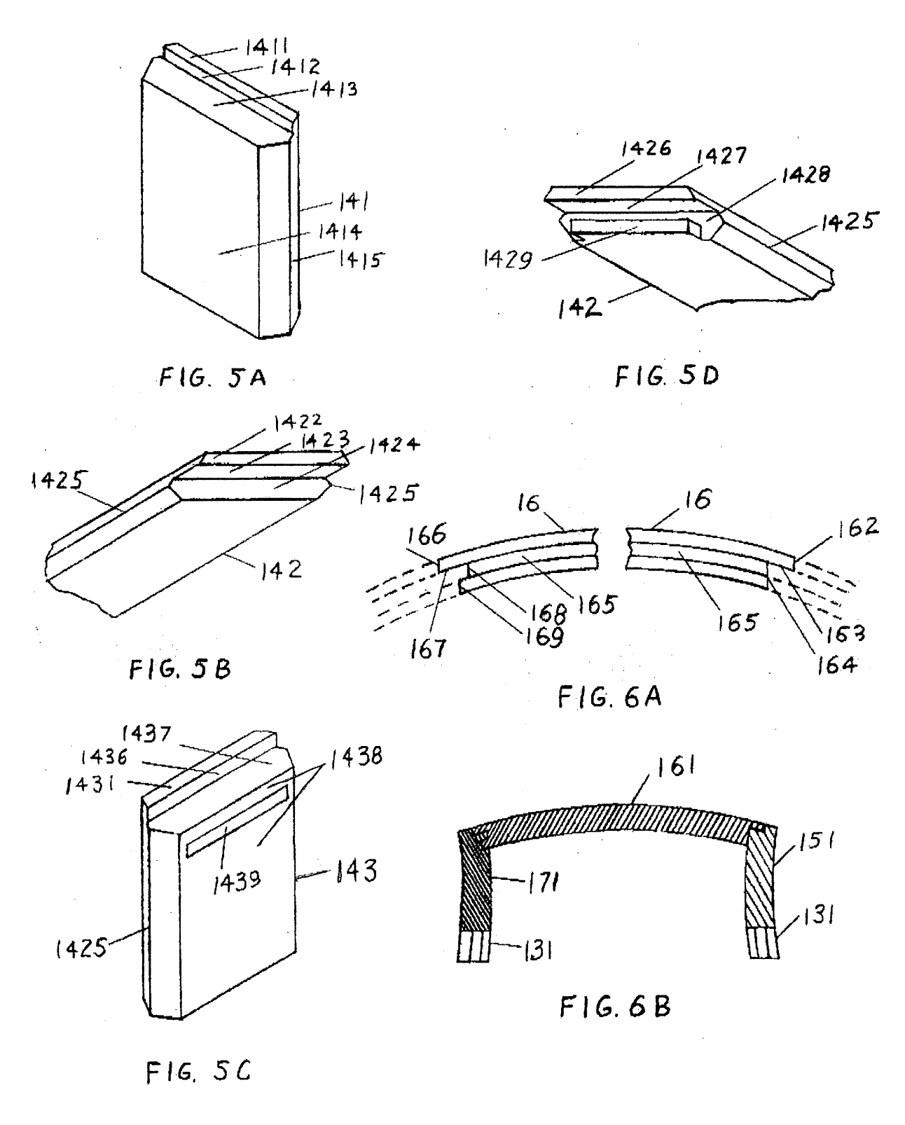

FIG. 5 shows a variation of slide design. In this figure, the slide 14 has tapered edges designed to slide in corresponding grooves in the cap body 12. Other variations of slide form would be obvious to those skilled in the art and it is not specifically necessary that each slide in a particular closure have the same design.

The tapered edges of slide 14 shown on FIG. 5 are better illustrated on FIGS. 5 A, B, C and D. In FIG. 5A the right side of vertical slide is identified as 141. The correlated horizontal slide 142 is detailed in FIGS. 5D and B. The left vertical slide 143 is shown in Fig. SC. As in previous figures, the vertical slides 141 and 143 are shown as flat rather than curved for ease of representation only. The top surface 1411 of slide 141 forms part of the top surface of the closure 12 (not shown) analogous to the closure 4. Surface 1412 mates with surface 1422 of slide 142. In the same manner, surface 1413 mates with 1423, and the upper portion of surface 1414 mates with 1424. The guide of slide 141 is shown as 1425, and the guide of slide 142 is shown as 1425. The entire top surface of slide 142 forms a part of the top surface of closure 12. Slide 143 is shown in FIG. 5C and the opposite end of slide 142 is depicted in FIG. 5D. As above, the guides of these slides are identified as 1435 and 1425. In FIG. 5C the surface 1431 forms a part of the top surface of closure 12, while surface 1436 mates with 1426. Surface 1437 mates with 1427, and the top portion 1438 mates with 1428. In the closed position, tab 1429 is in the slot 1439.

FIG. 6A shows the detail of the curved slide 16 of FIG. 6. This slide interlocks with slide 15 shown in FIG. 6 slide 17 (not shown) which is behind slide 15 and is located on the opposite side of the closure 18 of FIG. 6. The surfaces 162, 163 and 164 mate with corresponding surfaces of slide 15, and the surfaces 166, 167 and 168 mate with the surfaces of the slide 17. The tab 169 enters a corresponding slot in the slide 17. Slide 16 also includes the groove 165 which moves in a corresponding tongue part of closure 18.

The dashed lines indicate the path of the movement of slide 16. It may be seen that when the side surfaces of slide 16 are the arcs of concentric circles with corresponding arced paths formed in the closure 16, slide 16 is freely and easily movable to the right or to the left to open or close the closure 18.

FIG. 6B is a further embodiment of the present invention wherein all three interlocking slides move in curved paths. In this case the top slide is 161 and the vertical slides are 151 and 171. Slide 151 and 171 can be moved downward into the open spaces 131. Since other elements of the closure, such as the internal structure of the closure and the locking tabs have been shown in previous figures, they are not shown in FIG. 6B. It is clear, however, that a closure with the slide configuration of FIG. 6B could be fitted to a container, such as container 8 of FIG. 3.

This type of closure may be desirable for shape or style purpose only, and the outer shape of slides 151 and 171 are more in conformity with the shape of a finger or thumb than of flat vertical slides.

FIG. 6 shows a curved or rounded closure design. Here, slides 15 and 16 correspond to slides 1 and 2 of FIG. 1, but slide 16 moves in a curved plane rather than a flat one. Slide 15 can be moved into the free space 13 for opening, corresponding to the free space 13 of FIG. 3. These slides and one not seen, which would be numbered 17, corresponding to slide 3 of FIG. 1, are mounted in a closure 18 corresponding to the closure 4 of FIG. 1. The closure is mounted on the bottle 19 corresponding to the bottle 8 of FIG. 1. It is clear that other shapes or styles of cap are within the scope of the disclosed invention.

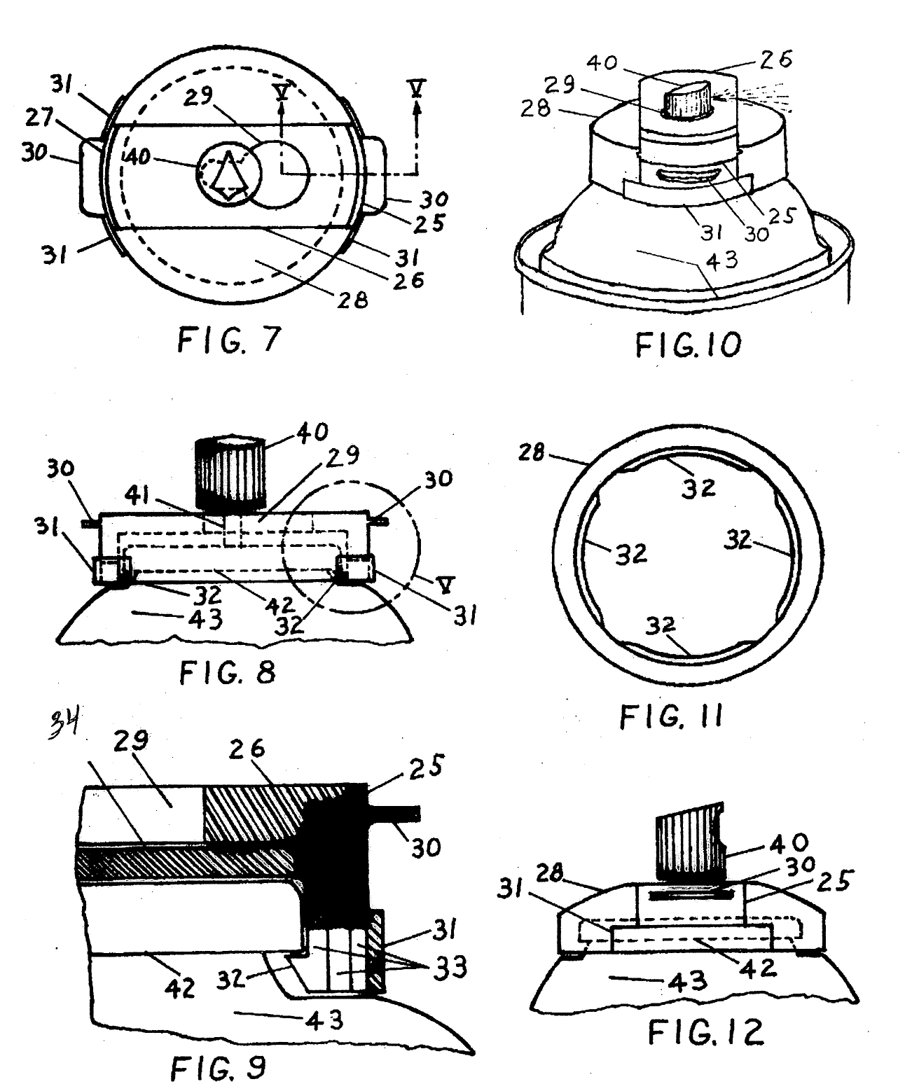

A closure for a typical aerosol valve and can assembly is shown in its top view in FIG. 7. The three slides are shown as 25, 26, and 27, where slides 25 and 27 are vertical and slide 26 is horizontal. Slide 26 includes an opening 29 which restricts and controls the movement of the aerosol valve actuator 40. Slides 25 and 27 each include a tab 30 for ease of movement of the slides. In this embodiment, the free spaces below slides 25 and 27 are covered with skirts 31 to conceal the fact that the slides can be moved downward.

FIG. 8 is a side view of the same closure showing its installed position on the aerosol valve. The relative location of the tabs 30 and the skirts 31 can be clearly seen in this view. The actuator 40 is shown together with the stem 41 of the actuator as it is installed in the aerosol valve 42. While the actuator stem 41 goes through the opening 29, it is clear from FIGS. 7 and 8 that the actuator 40 cannot be depressed to open the aerosol valve 42 when the closure is in its closed position. The retaining tabs 32 of the of the closure device are shown latched under the edge of the aerosol valve assembly, and the closure cap 28 is seated on the body 43 of the aerosol can.

FIG. 9 is a cross-sectional view through plane V. Here, the interlocking of slides 25 and 26 is shown, as well as the tab 30 which is an integral part of slide 25. The skirt 31 is shown covering the open space below slide 25 and the grooved slide guide 33 can be seen through the open space. The locking tabs 32 hold the closure on the valve assembly 42, but allow the closure to be rotated, further concealing the means of opening the closure. The closure 28 has an internal structure 34 for mechanical rigidity. This internal structure has a central hole, not shown in the figure, directly below the actuator 40 so that when the closure is in the open position, the actuator 40 can be pushed down through the opening 29 and the central hole in the closure structure 28 to open the aerosol valve and release the contents of the container.

The opposite end of slide 26 is interlocked with slide 27 in the same manner as slides 2 and 3 are shown interlocked in FIG. 3. To open the closure, slide 25 is moved downward until it is stopped by the aerosol can 43. Then, slide 26 is moved to the right until the opening 29 is stopped by the actuator stem 41. In this position, slide 27 is moved downward until it is stopped by the aerosol can 43 and slide 26 is moved to the left until the larger part of opening 29 is under the actuator 40. In this position, the aerosol actuator is depressed, opening the aerosol valve 42 to release the contents of the aerosol can.

After use, slide 26 is moved to the right so that slide 27 can be raised to its upper or closed position. Slide 26 is then moved to the left to interlock with slide 27 and slide 25 is moved upward to interlock with slide 26 completing the closure. Again, little force is necessary to move the slides, since the sequence of movements is the key to opening or closing this virtually child proof closure.

The grooved part or slide guide 33 of the closure 28 that allows slide 25 to be moved down and up is similar to groove 11 of FIG. 3. The closure body 28 has an internal structure 34 for mechanical rigidity. The closure 28 and internal structure are similar to the closure 4 and the internal structure 5 of FIGS. 2 and 3, except that the internal structure has no opening for removal of content. The content of the aerosol can are released by the depression of the actuator 40 to open the valve 42.

The slide guide 33, which is part of the closure body 28, is of the same form as guide 11 of FIG. 3 and FIG. 4A.

FIG. 10 is a perspective view of the closure in the open, operating position. Slide 25 has been moved downward by means of tab 30, and slide 26 has been moved to the position where the actuator 40 can be depressed through the large portion of the opening 29. Even in the open position, the means of the interlocking and operating of the closure is not very readily apparent. It may also be noted in FIG. 10 that the diameter of the closure is smaller than that of the aerosol can 43 and lower than that of the actuator 40 so that the aerosol can and closure can be covered with a conventional aerosol can overcap.

FIG. 11 is a bottom view of the closure body 28 showing an arrangement of the retaining tabs 32. Other forms of closure tabs or rings are well-known in the closure industry.

FIG. 12 is a side view of a closure with a rounded or curved top which would require a smaller volume of material to produce the closure and would also allow for a wider angle of spray from the nozzle of the actuator 40. Other shapes or forms can obviously be designed for specific situations or applications. The closures shown are well-suited to production operations since no radial alignment of the closure is required and it can be installed mechanically after the aerosol can has been filled but before the actuator 40 is installed in the aerosol valve. It would also be possible to supply a closure and matching actuator that could be retrofitted on aerosol cans that are already in use. This could be advantageous since some aerosol products such as special lubricants, auto touch-up paint and the like are often kept and used over a period of years.

Many aerosol cans fitted with actuators and cover assemblies that are too large to be protected by a closure that is fitted to the aerosol valve assembly. An embodiment of the invention to meet the needs of a typical large actuator assembly is shown in FIG. 13 and following figures. FIG. 13 is a top view of a closure which fits over, and is retained by the aerosol can structure, encompassing not only the aerosol valve assembly but also the top of the aerosol can. There have been injuries when people have encountered a malfunctioning aerosol can and resorted to a can opener or other tool to pierce the top of the can and thereby releasing the flammable contents with unpleasant consequences. The closure shown in FIG. 13 would make that type of occurrence extremely difficult. In FIG. 13 the three interlocking slides are identified as 51, 52 and 53. They are installed and operate within the closure or cap identified as 54. The slide 52 includes an opening 55 which, in its closed position, prevents, and in its open position allows operation of the actuator 60. To aid in visualizing the closure, the interior side of the closure is identified as 59 and the exterior of the aerosol can below the closure is identified as 63. In reference to preceding drawings, the slides 51, 52, and 53 correspond to slides 1, 2, and 3 of FIG. 1 and also to slides 25, 26 and 27 of FIG. 7.

FIG. 14 is a side view of the same closure showing the interrelation and interlocking of slides 51, 52 and 53. The vertical slides 51 and 53 could be fitted with tabs for ease of operation such as the tabs 30 shown in FIGS. 7, 8 and 9. Also, they could include, along with slide 52, a roughened or knurled surface or indentations to accommodate a thumbnail or fingernail to facilitate their movement. These variations of convenience are shown in later drawings.

In this embodiment, the slides 51 and 53 include internal tabs 58 which limit the downward movement of the slides when they encounter the body of the aerosol can 63. The actuator 60 is shown in its normal or closed position above the aerosol valve 62 which is installed on and sealed to the aerosol can 63. The closure cap 54 is held on to the aerosol can by means of the retaining tabs 57 and the internal structure necessary for the strength and rigidity of the closure 54 is identified as 56. The dashed line between the lower parts of the internal structure 56 shows that the internal structure is a circumferential interior part of the cap 54.

FIG. 15 is a cross-sectional view taken through the plane X-X of FIG. 13. Slides 51 and 53 are seen with their internal tabs 58 which are an integral part of the slides. Here it can be clearly seen that the downward movement of slides 51 and 53 are limited and stopped when the tabs 58 encounter the aerosol can body 63. In this cross-sectional view, the internal structure 56 has a small clearance from the slides 51 and 53 to allow easy movement of the slides and a similar small clearance to allow easy movement of slide 52. In the parts of the closure, the internal structure 56 is an integral part of the cap 54. In this embodiment, slides 51 and 53 also have retainer tabs 58 which limit their upward movement and prevent them from being removed from the closure cap.

To open the closure, slide 51 is moved downward and is stopped by tab 58. Then, slide 52 is moved to the right to release the interlocking of slide 52 with slide 53. It may be noted that the opening 55 provides sufficient clearance to the left of the actuator 60 to allow the necessary movement of slide 52 to the right. Then, slide 53 is moved downward until it is stopped by its tab 58 and slide 52 is moved to the left until the larger part of the opening 55 is under the actuator 60. In this position, the actuator 60 can be depressed to release the contents of the aerosol can.

FIG. 16 is a cross-sectional view taken through the plane XI-XI of FIG. 13. Here, it can be seen that the downward and sideways movement of the actuator 60 is prevented by slide 52 when it is in the closed position. It may also be noted that there is only a small clearance between the slide 52 and the aerosol valve assembly 62 so that even a large downward force such as a hammer blow would, at worst, only produce a brief and minute discharge from the aerosol can. It is important to note that the valve assembly 62 is different from the valve assembly 42 shown in FIGS. 8, 9 and 12. In those figures, the actuator 40 and stem 41 are an integral unit which fits into a hole in the center of the valve assembly 42. In FIG. 16, the stem 61 is part of the valve assembly 62 and the actuator 60 is fitted on the stem 61.

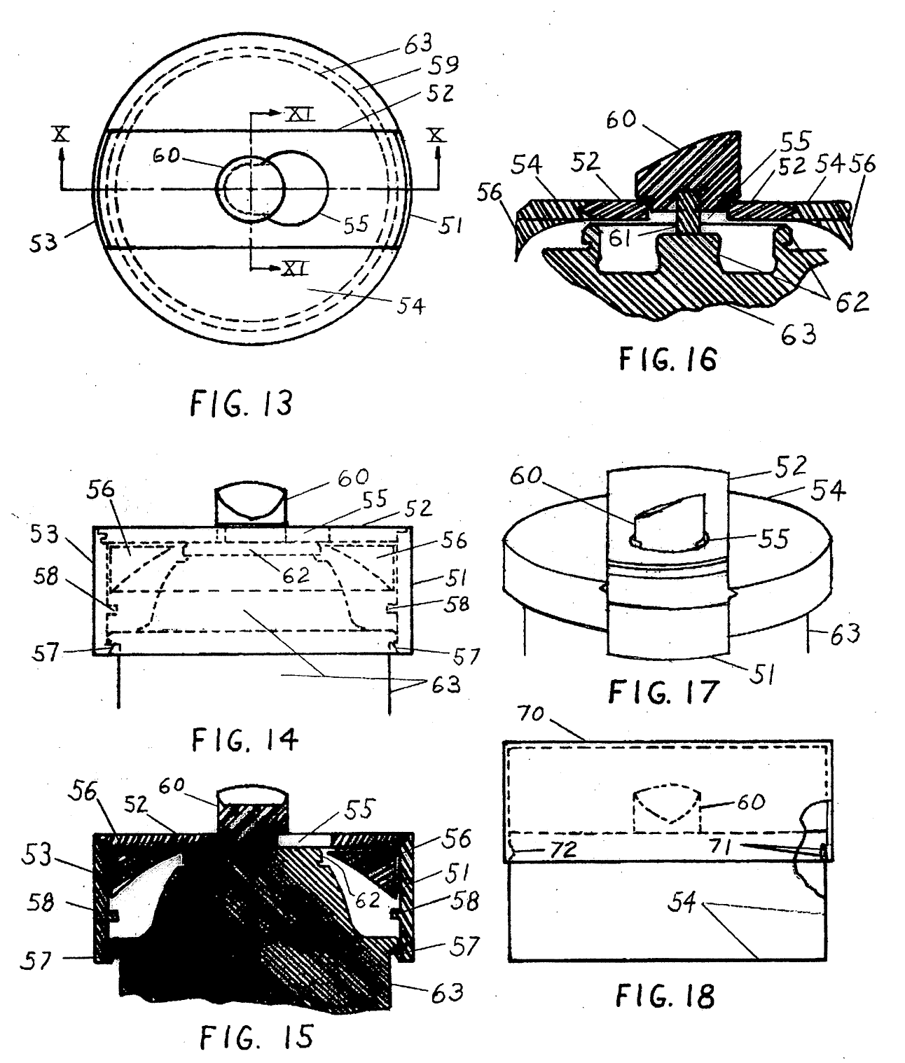

FIG. 17 is a perspective view of the closure shown in FIGS. 13, 14, 15 and 16. Here, the closure is in the open position with slide 51 lowered and slide 52 moved so that the large part of opening 55 is under the actuator 60 allowing it to be depressed. It may be noticed that there is enough clearance for the actuator 60 to also be moved horizontally or toggled. The closure shown in FIGS. 13-17 is also well suited to production line operations since it can be installed on the tilled aerosol can 63 without need for radial alignment and the actuator 60 can be installed on the stem 61 after the closure cap is in place.

Actuator 60 moves horizontally (within a limited plane) to allow changing the direction of the spray without moving the position of the aerosol can. Such types of actuators are known in the art to be used as hair spray to allow spraying a larger area of hair without moving the can. Present invention is not restricted to can and actuator design shown of FIG. 17 and any other variants can be used within the scope of the present invention.

There are other types of actuators which are designed to extend down into the open space of the aerosol valve 62. These large actuators could be restricted or protected since a slot in each side of the actuator would allow it to be restrained by slide 52 or operated when slide 52 was in the open position. For such actuators, the cap 54 could be installed in the open position and the actuator 60 could be installed. For these actuators, the slots in the actuator would have to be aligned with the narrower portion of the opening 55 in slide 52 so that the closure cap could be moved to its closed position before packing and shipping.

FIG. 18 shows a closure 54 modified with a groove 72 to accept the retaining rings 71 of a conventional type of cover cap 70. The actuator 60 is shown to indicate how the cover cap would protect the closure 54 and the actuator 60 from damage by very rough handling during shipment or later use.

In the embodiments shown in FIGS. 1-18 and described in detail above, the child proof closures are attached to the containers of any harmful or potentially dangerous substance. Once installed on a container, the closure cannot be removed or pulled off even by a very strong adult. Additionally, the clearance between the closure cap and the container is small enough that it could not be pried off with a typical screwdriver or similar tool. It would require a combination of tools such as a thin-blade screwdriver and a hammer to drive the screwdriver blade into the space between the cap and the container to apply leverage between the cap and the container. With a typical plastic closure there would be enough deformation of the closure that a single leverage point would probably not be sufficient to release all of the retaining tabs. More probably at least two or three leverage points would be necessary to cause complete separation of the closure and the container. It is very unlikely that a young child would have the knowledge, experience and dexterity to defeat the closure through a repeated use of a combination of tools.

In many applications it is desirable to have a virtually child proof closure or cap that can be removed from the container to gain access to contents in solid (powder), liquid or viscous (salves and ointments) forms.

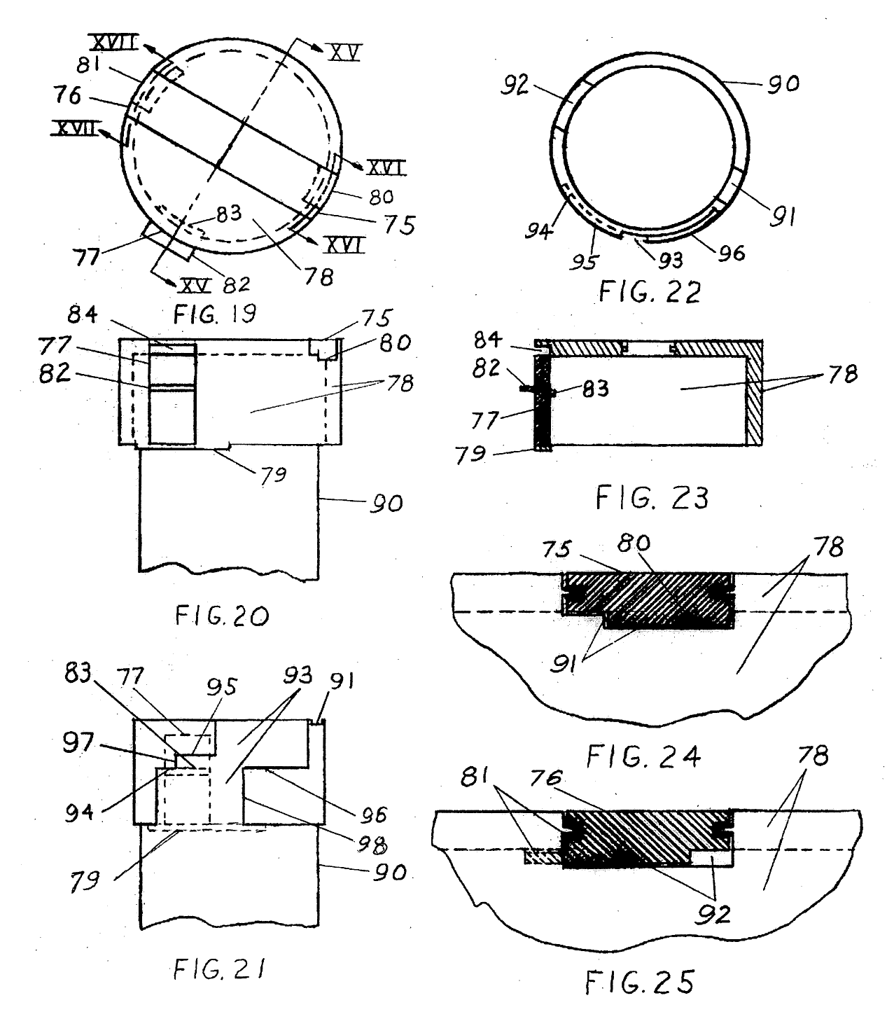

An embodiment of the invention to meet these requirements is shown in FIGS. 19-28. FIG. 19 is a top view of a closure which can be removed from the container. It comprises two horizontal slides 75 and 76 and a vertical slide 77, all mounted in the closure cap 78. Slide 75 includes a locking piece 80 and slide 76 includes a locking piece 81. The vertical slide 77 includes a locking tab 83 and a movement facilitating tab 82.

FIG. 20 is a side view of the closure 78 and the container 90. This side view shows the slide 75 with its locking piece 80 which are installed in the closure cap 78. The vertical slide 77 is shown with its movement tab 82. In this embodiment, downward movement of the slide 77 is limited by the skirt 79 which is an integral part of the closure 78. Upward movement of the slide 77 is allowed by the open space 84.

FIG. 21 shows the form and structure of a container 90 designed to operate in conjunction with the closure 78. The container 90 is moulded or otherwise fabricated to include an outer form or surface comprising elements 91, 92, 93, 94, 95, 96, 97, and 98. An additional element 92 is not visible in FIG. 21 but is shown in a later figure. Also shown in a “phantom view” is slide 77 and its locking tab 83, both in their closed position. If it were desirable for convenience, technical or economic reasons, the limiting skirt 79 could be formed as part of the container 90 rather than as part of the closure cap 78 as shown in FIG. 20. This alternate form is indicated in FIG. 21 where a “phantom” outline of the limiting skirt 79 in the location it would have if it were part of the container 90. Since it would extend outward from the indicated form of container 90, it is not suggested that this would be a preferable option. The slot 91 allows the outward and inward movement of locking piece 80 and slide 75 which includes locking piece 80. The open space 93 allows movement of the slide 77 and its locking tab 83, but the movement of the slide 77 and the locking tab 83 are limited and controlled by the surfaces or edges 94, 95, 96, 97, and 98.

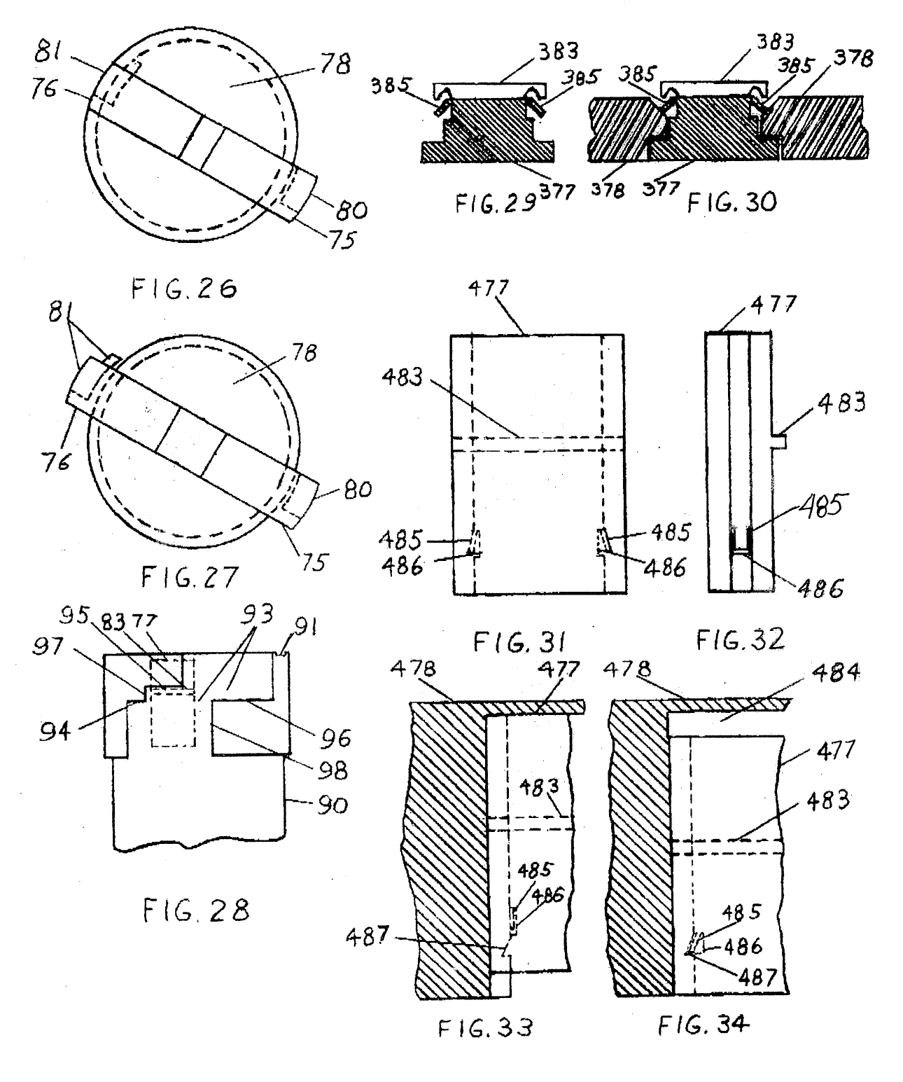

Container 90 of FIG. 21 is the part of the present invention and is also illustrated in FIGS. 26-34.

FIG. 22 is a top view of the container 90 which shows the slot 91 which allows the outward and inward movement of the locking piece 80, and slot 92 which, in proper sequence, allows the outward and inward movement of locking piece 81 which is a part of slide 76. The open space 93 is depicted with its limiting edges 94, 95, and 96.

FIG. 23 is a cross-sectional view taken through the plane XV-XV of FIG. 19. It shows the closure structure 78 and by inference, its circumferential form. Slide 77 is shown with its locking tab 83 and its movement tab 82. The downward movement of slide 77 is clearly limited by the skirt 79, yet it can be moved upward into the open space 84. The closure structure 78 also shows structure of the tongue and groove path for slides 75 and 76. This slide path is empty since the cross-section XV-XV represents the small but finite space between the inner ends of slides 75 and 76, and neither of the slides occupies this thin space between them.

FIG. 24 is a cross-sectional view taken through the curved plane XVI-XVI of FIG. 19. Slide 75 is seen with its locking piece 80, installed in the closure cap 78. The slot 91, which is a part of the container 90, is shown in its relation to slide 75 and its locking piece 80. It is clear that locking piece 80 can be moved outward or inward through slot 91. While slot 91 can be seen, container 90 is slightly behind the plane of the cross-sectional view and is thus not seen in the figure.

FIG. 25 is a cross-sectional view taken through the curved plane XVII-XVII of FIG. 19. The slide 76 is seen with its locking piece 81 that is partly concealed behind the side wall of the closure cap 78. As in FIG. 24, slide 76 and the locking piece 81 are installed in the closure cap 78. Slot 92, which is a part of the container 90, is shown in its relation to slide 76 and its locking piece 81. It can be seen that if the closure 78 were rotated to the right (counterclockwise) that the locking piece 81 could be moved through the slot 92.

Regarding FIGS. 19-28, it is clear that rotation of the cap relative to the container is prevented by locking piece 80 which is engaged in slot 91 of the container 90. If locking piece 80 were missing, broken or vaporized by a laser beam, rotation is still prevented by locking piece 81 and slot 92. Upward movement of the closure is prevented by locking tab 83 which cannot be moved upward due to the restraint by surface 94 of the container 90. It should be noted that there is only a small clearance between the inside surface of the closure cap 78 and the outside surface of the top of container 90 which is formed to include surfaces 94, 95, 96, 97, and 98. Thus, the closure cannot be opened by prying with a screwdriver, twisting with pliers or other tools commonly available. Nothing less than a blow from a large hammer, sufficient to crush the container and/or closure would allow access to the contents of the container.

The operation and use of the closure can be easily understood by regarding FIGS. 19-28 in concert. Looking at the top view of the closure in FIG. 19, 24 and at FIG. 26 it is clear that slide 75 and its locking piece 80 can be moved outward until locking piece 80 is clear of the slot 91 and no longer restricts the rotational movement of the closure 78. Then, closure 78 is rotated slightly to the left (counterclockwise) to align the locking piece 81 with the slot 92 of FIG. 25, so that slide 76 can be moved outward until locking piece 81 is clear of the slot 92 as on FIG. 27.

The same rotation that allows slide 76 and its locking piece 81 to be moved outward through slot 92 also moves slide 77 to the right so that it is clear of surface 94 as on FIG. 28. In this position, slide 77 is moved upward by means of the movement tab 82 (FIG. 23) until it is stopped when locking tab 83 encounters surface 95 of the container 90. In this position, the closure cap can be further rotated to the left (counterclockwise) so that locking tab 83 moves into the open space 93 and when tab 83 is clear of the surface 95 the closure cap can be lifted and removed from the container 90.

It may be noted that even after locking pieces 80 and 81 are moved into their open position free of slots 91 and 92, the cap still cannot be removed with slide 77 in its closed position. With slide 77 in the closed position the cap can only be rotated until slide 77 is stopped by surface 98 and upward movement of the cap is stopped when the left side of locking tab 83 encounters surface 95. Thus, if only slide 77 is in the closed position, there is still an element of child resistance if slides 75 and 76 were left in their open positions. Since the closure looks a little awkward or untidy when slides 75 and 76 are in their open position, most adults would return slides 77, 76 and 75 to their closed positions to regain the neat and tidy look of the container in its normal closed position. This is particularly true once they know they will not have any physical difficulty in reopening or closing the container in further use. It is highly unlikely that a young child would be able to learn and execute the proper sequence of movements to place all three of the slides 75, 76 and 77 in their open positions and further rotate the cap 78 to lift it from the container 90 and gain access to the contents of the container. In fact, most adults, without prior instruction or experience, would have difficulty in opening the closure in a reasonable amount of time. This means that even older children or adults with limited or deteriorated mental ability could not devise the means of opening the closure and gain access to the contents of the container.

By regarding FIGS. 19 and 22, it can be seen that further security could be provided by using the open circumferential space of the closure 78 between slides 75 and 76 and the open circumferential space of the container 90 between the slots 91 and 92 to install an additional vertical slide in the closure corresponding to and opposite from slide 77 and an additional form of restraining surfaces on the container 90 corresponding to and opposite from space 93 and surfaces 94-98.

FIGS. 29-34 show means of preventing the removal of slide of FIG. 19-26 illustrating small tabs 485 on the sides of slide 477 cooperating with a corresponding notches 487 formed in grooved portions of closure 78 that would limit downward movement of slide 77 Thus, it can be seen that the objects of the present invention have been satisfied by the structure presented hereinabove. While in accordance with the Patent Statutes, only the best mode and preferred embodiments of the present invention have been presented and described in detail, it is to be understood that the invention is not limited thereto or thereby.

1. Child-proof closure for a container containing dangerous substance comprising:
a body adapted to be fitted over said container,
said body having a top portion and a continuous side wall depending downwardly from said top portion;
a series of interlocking elements located on said top portion and said side wall,
said interlocking elements are adapted to move in a predetermined sequence of steps to facilitate an access to said substance.

2. Child-proof closure according to claim 1, wherein said interlocking elements are slides adapted to slide within corresponding grooves formed in said top portion and said side wall.

3. Child proof closure according to claim 1, wherein said side wall has a cylindrical configuration.

4. Child-proof closure according to claim 1, wherein said closure further comprises a membrane member incorporated in a spaced relationship underneath said top portion, said membrane member comprising an opening provided for limited distribution of said substance;
wherein said opening is accessible only after said interlocking elements are placed into an operative or open position.

5. Child-proof closure according to claim 2, wherein said closure comprises a horizontal slide and two vertical slides adapted to interlock opposite sides of said horizontal slide;
wherein said horizontal slide is adapted to move left and right and wherein said vertical slides are adapted to move down;
and wherein in closed position said vertical slides are adapted to lock the movement of said horizontal slide.

6. Child-proof closure according to claim 2, wherein said container is provided with a first ring formed near a mouth portion of said container, said first ring is adapted to cooperate with corresponding locking tabs formed in a lower part of said side wall of said closure, said first ring and said locking tabs facilitate a secure locking of said closure on said container.

7. Child-proof closure according to claim 6, wherein said container is provided with a second ring, said second ring is spaced underneath of said first ring and is provided to restrict downward movement of said vertical slides.

8. Child-proof closure according to claim 5, wherein each of said slides if provided with locking tabs adapted to cooperate with corresponding catches formed within said grooves, said locking tabs are adapted to prevent removal of said slides from said closure.

9. Child-proof closure according to claim 1, wherein said container contains a drug substance, and wherein said opening is adapted to facilitate a limited dispensing of said drug from said container.

10. Child-proof closure according to claim 5, wherein said container is an aerosol can and wherein said slides are adapted to restrict access to a valve actuator.

11. Child-proof closure according to claim 10, wherein said horizontal slide is provided with an opening having a configuration provided to restrict and control the movement of said valve actuator, wherein said valve actuator is capable to be depressed only after all slides are moved into an operative or open position.

12. Child-proof closure according to claim 10, wherein said closure is adapted to be securely locked on said aerosol can by means of locking tabs formed in a lower portion of said closure, wherein said locking tabs are adapted to snap on an outer edge of said valve actuator.

13. Child-proof closure according to claim 12, wherein downward movement of said vertical slides is restricted by an upper shoulder of said aerosol can.

14. Child-proof closure according to claim 2, wherein said closure comprising two horizontal slides located on said top portion and one vertical slide located on said side wall, said horizontal and vertical slides are adapted to be interlocked between each other.

15. Child proof closure according to claim 14, wherein said container is provided with a number of elements formed around an outer wall of said container, said elements are adapted to cooperate with said slides of said closure to facilitate a complete removal of said closure from said container.

16. Child-proof closure for a container containing dangerous substance comprising:
a body adapted to be fitted over said container, said body having a top portion and a continuous side wall depending downwardly from said top portion;
a series of interlocking elements located on said top portion and said side wall, said interlocking elements are adapted to move in a predetermined sequence of steps to facilitate an access to said substance;
wherein said interlocking elements are slides adapted to slide within corresponding recesses formed in said top portion and said side wall.

17. Child-proof closure according to claim 16, wherein said closure further comprises a membrane member incorporated in a spaced relationship underneath said top portion, said membrane member comprising an opening provided for limited distribution of said substance;
wherein said opening is accessible only after said interlocking elements are placed into an operative or open position.

18. Child-proof closure according to claim 16, wherein said closure comprises a horizontal slide and two vertical slides adapted to interlock opposite sides of said horizontal slide;
wherein said horizontal slide is adapted to move left and right and wherein said vertical slides are adapted to move down;
and wherein in closed position said vertical slides are adapted to lock the movement of said horizontal slide.

19. Child-proof closure according to claim 16, wherein said container is provided with a first ring formed near a mouth portion of said container, said first ring is adapted to cooperate with corresponding locking tabs formed in a lower part of said side wall of said closure, said first ring and said locking tabs facilitate a secure locking of said closure on said container; and wherein said container is provided with a second ring, said second ring is spaced underneath of said first ring and is provided to restrict downward movement of said vertical slides.

20. Child-proof closure according to claim 16, wherein said container is an aerosol can and wherein said slides are adapted to restrict access to a valve actuator, wherein said horizontal slide is provided with an opening having a configuration provided to restrict and control the movement of said valve actuator, wherein said valve is capable to be depressed only after all slides are moved into an operative or open position.

21. Child-proof closure according to claim 16, wherein said closure comprising two horizontal slides located on said top portion and one vertical slide located on said side wall, said horizontal and vertical slides are adapted to be interlocked between each other, and wherein said container is provided with a number of elements formed around an outer wall of said container, said elements are adapted to cooperate with said slides of said closure to facilitate a complete removal of said closure from said container.
